(19) United States
(12) Patent Application Publication
(10) Pub. No.: US 2015/0103703 A1
(43) Pub. Date: Apr. 16, 2015

(54) Resource Allocation In Different TDD Configurations With Cross Carrier Scheduling

(71) Applicants: Erlin Zeng, Beijing (CN); Jing Han, Beijing (CN); Chunyan Gao, Beijing (CN); Wei Bai, Beijing (CN); Haiming Wang, Beijing (CN); Wei Hong, Beijing (CN)

(72) Inventors: Erlin Zeng, Beijing (CN); Jing Han, Beijing (CN); Chunyan Gao, Beijing (CN); Wei Bai, Beijing (CN); Haiming Wang, Beijing (CN); Wei Hong, Beijing (CN)

(73) Assignee: Broadcom Corporation, Irvine, CA (US)

(21) Appl. No.: 14/395,201

(22) PCT Filed: Apr. 20, 2012
(86) PCT No.: PCT/CN2012/074450

§ 371 Date: Oct. 17, 2014

(51) Int. Cl. H04W 72/04; H04L 5/00; H04W 72/14; H04L 5/14

(52) U.S. Cl. CPC H04W 72/042; H04L 5/14; H04L 5/0092; H04W 72/14
USPC 370/280

(57) ABSTRACT

A downlink resource grant is on a first component carrier having a first downlink to uplink DL/UL subframe configuration, and cross schedules to a second component carrier having a different second DL/UL subframe configuration. If a first set SI of downlink subframes associated with a subframe n of the first DL/UL subframe configuration only partially overlaps with a second set S2 of downlink subframes associated with the subframe n of the second DL/UL subframe configuration, then explicit signaling is utilized to select whether uplink radio resources in subframe n for channel selection are implicitly or explicitly allocated. If instead SI does not only partially overlap SI, then a default rule is utilized for allocating the uplink radio resources in subframe n for channel selection. In different examples the explicit signaling is higher layer signaling which configures a UE; or a predetermined state in a field of the PDCCH.

### TECHNICAL FIELD

The exemplary and non-limiting embodiments of this invention relate generally to wireless communication systems, methods, devices and computer programs, and more specifically relate to allocating radio resources for feedback signaling when cross carrier scheduling is used for different configurations of uplink and downlink subframes.

### BACKGROUND

One improvement that enables 4G technology (also known as evolved UTRAN or long term evolution LTE®) to offer much higher data rates than 3G (also known as UTRAN) is the concept of carrier aggregation, in which the whole bandwidth is divided into several component carriers and each UE is assigned one primary component carrier (sometimes termed a primary cell or PCell) and may additionally be assigned one or more secondary component carriers (sometimes termed a secondary cell or SCell). Cross carrier scheduling refers to one physical downlink control channel PDCCH granting resources to a UE on multiple component carriers. The examples below assume that the PDCCH is sent on the PCell and schedules radio resources for a UE on the PCell and on one SCell, but this is a typical but non-limiting example of cross carrier scheduling. The PDCCH is also sometimes referred to as a resource grant, or downlink control information (DCI) which in LTE® has different sizes indicated by the DCI format.

It is anticipated that a future release of LTE®, to be termed LTE-A (A=advanced) will support different time domain duplex (TDD) uplink to downlink subframe ratios on different bands/component carriers, as an enhancement for carrier aggregation. In the LTE® technology these different TDD ratios are categorized as uplink/downlink (UL/DL) configurations.

The downlink resource allocated by a PDCCH is a physical downlink shared channel PDSCH and the uplink resource is a physical uplink shared channel PUSCH. For the downlink case, the user equipment tunes to receive its scheduled PDSCH and replies with feedback according to a hybrid automatic repeat request HARQ process associated with that PDSCH. In this HARQ process the UE informs the network access node (eNB) on a physical uplink control channel PUCCH an acknowledgement (ACK) or negative acknowledgement (NACK) whether it received the PDSCH properly. With cross carrier scheduling the location of the PUCCH implicitly maps from the lowest control channel element CCE of the PDCCH that scheduled the PDSCH which is being ACK'd/NACK'd.

A problem arises if cross carrier scheduling is allowed where the PCell and the SCell have different UL/DL configurations. If the ACK/NACK feedback for both the PCell and the SCell is to always be sent on the PCell, then the different UL/DL configurations can result in either a conflict where both implicitly mapped PUCCHs collide with each other, or inefficiencies in the eNB's scheduling if it were to take that conflict into account when making its resource allocations in the PDCCH.

### SUMMARY

In a first exemplary embodiment of the invention there is a method for selecting uplink radio resources, comprising: for a downlink resource grant on a first component carrier having a first downlink to uplink subframe configuration that cross schedules to a second component carrier having a different second downlink to uplink subframe configuration, determining whether a first set S1 of downlink subframes associated with a particular subframe (subframe n) of the first downlink to uplink subframe configuration only partially overlaps with a second set S2 of downlink subframes associated with the particular subframe (the same subframe n) of the second downlink to uplink subframe configuration. If the determination is that the first set only partially overlaps the second set, then utilizing explicit signaling to select whether uplink radio resources in the particular subframe for channel selection are implicitly or explicitly allocated. Else if the determination is that the first set does not only partially overlap the second set, utilizing a default rule for allocating the uplink radio resources in the particular subframe for channel selection.

In a second exemplary embodiment of the invention there is an apparatus for selecting uplink radio resources, and the apparatus comprises a processing system such as for example at least one memory including computer program code and at least one processor. In this exemplary embodiment the processing system is configured to cause the apparatus to perform: for a downlink resource grant on a first component carrier having a first downlink to uplink subframe configuration that cross schedules to a second component carrier having a different second downlink to uplink subframe configuration, determining whether a first set S1 of downlink subframes associated with a particular subframe (some subframe n) of the first downlink to uplink subframe configuration only partially overlaps with a second set S2 of downlink sub frames associated with the particular subframe (the same subframe n) of the second downlink to uplink subframe configuration; and if the determination is that the first set only partially overlaps the second set, then utilizing explicit signaling to select whether uplink radio resources in the particular subframe for channel selection are implicitly or explicitly allocated; else if the determination is that the first set does not only partially overlap the second set, utilizing a default rule for allocating the uplink radio resources in the particular subframe for channel selection.

In a third exemplary embodiment of the invention there is a computer readable memory comprising a set of instructions, which when executed on a radio communications device, causes the radio communications device to perform the steps of: for a downlink resource grant on a first component carrier having a first downlink to uplink subframe configuration that cross schedules to a second component carrier having a different second downlink to uplink sub frame configuration, determining whether a first set S1 of downlink subframes associated with a particular subframe (some subframe n) of the first downlink to uplink subframe configuration only partially overlaps with a second set S2 of downlink subframes associated with the particular subframe (the same subframe n) of the second downlink to uplink subframe configuration; and if the determination is that the first set only partially overlaps the second set, then utilizing explicit signaling to select whether uplink radio resources in the particular subframe for channel selection are implicitly or explicitly allocated; else if the determination is that the first set does not only partially overlap the second set, utilizing a default rule for allocating the uplink radio resources in the particular subframe for channel selection.

In a fourth exemplary embodiment of the invention there is an apparatus for selecting uplink radio resources. In this embodiment the apparatus comprises determining means and choosing means. The determining means is for determining, for a downlink resource grant on a first component carrier having a first downlink to uplink subframe configuration that cross schedules to a second component carrier having a different second downlink to uplink subframe configuration, whether a first set S1 of downlink subframes associated with a particular subframe (some subframe n) of the first downlink to uplink subframe configuration only partially overlaps with a second set S2 of downlink subframes associated with the particular subframe (the same subframe n) of the second downlink to uplink subframe configuration. The choosing means is for utilizing explicit signaling to select whether uplink radio resources in the particular subframe for channel selection are implicitly or explicitly allocated if the determination is that the first set only partially overlaps the second set; else for utilizing a default rule for allocating the uplink radio resources in the particular subframe for channel selection if the determination is that the first set does not only partially overlap the second set.

As non-limiting examples for this fourth embodiment, the determining means and the choosing means comprise a processing system interfacing with at least a receiver in a user equipment or with at least a transmitter in a network access node. The processing system may be implemented as one or more processors executing computer program code stored on one or more memories.

### BRIEF DESCRIPTION OF THE DRAWINGS

FIG. 1 is a prior art timing diagram showing uplink and downlink subframes in two consecutive radio frames for a PCell and an SCell with different UL/DL subframe configurations, and illustrates one example in which these teachings may be used to advantage.

FIG. 2 is a logic flow diagram that illustrates a selection of how PUCCH resources are allocated in accordance with certain exemplary embodiments of these teachings.

FIG. 3 is a non-limiting example of exemplary electronic devices suitable for use in practicing some example embodiments of these teachings.

### DETAILED DESCRIPTION

To more particularly appreciate the advantages of the novel teachings herein, first is described examples of the conflicts and inefficiencies noted in the background section above. Regarding the PDSCH HARQ-ACK procedure when cross carrier scheduling is enabled and different TDD UL/DL configurations are allowed, the following points have recently been agreed in the document entitled RAN1 Chairman's Notes (3GPP TSG RAN WG1 Meeting #68; Dresden, Germany; 6-10 Feb. 2012):
For PUCCH transmission, PUCCH on PCell-only
No new HARQ-ACK timing
   Here “no new HARQ-ACK timing” means no new HARQ-ACK timing table beyond those already defined in Rel-8/9/10.
HARQ-ACK timing of PCell PDSCH, the scheduling timing of PCell PUSCH, the HARQ timing of PCell PUSCH should follow the PCell timing.
   PCell timing is the same as Rel-8/9/10
The PDSCH HARQ timing on SCell shall
   follow the PCell SIB1 configuration if the set of DL subframes indicated by the SCell SIB1 configuration is a subset of the DL subframes indicated by the PCell SIB1 configuration
   it is for further study if the set of DL subframes indicated by the SCell SIB1 configuration is NOT a subset of the DL subframes indicated by the PCell SIB 1 configuration

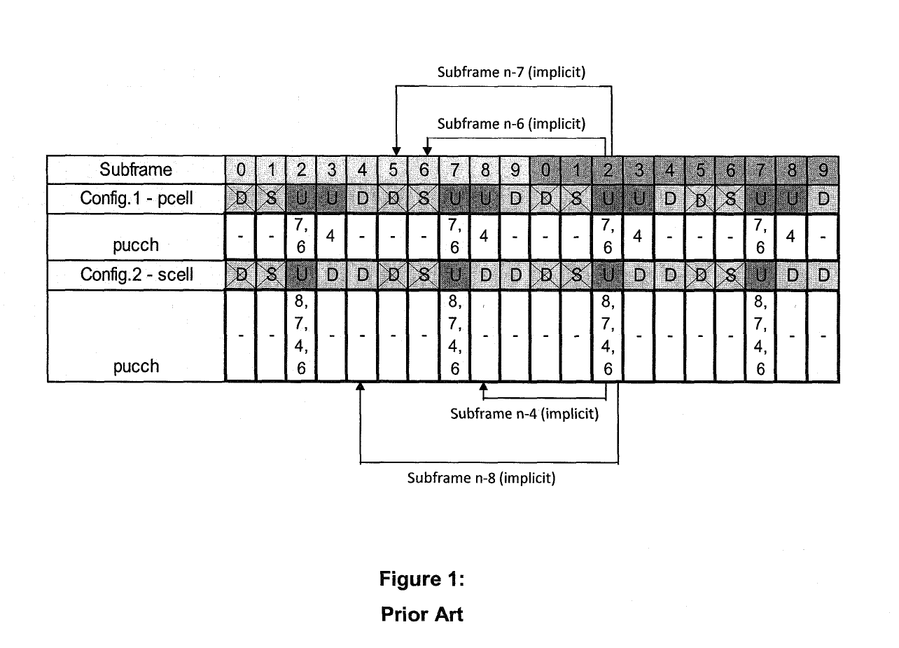

FIG. 1 illustrates two radio frames for the PCell and the SCell, where both PCell frames have the same UL/DL configuration #1 (6 DL and 4 UL, since switching subframes S are considered DL) and both SCell frames have the same UL/DL configuration #2 (8 DL and 2 UL) which is different than that being used on the PCell. The numbers in the rows entitled “pucch” refer to the location of the PDSCH associated with a PUCCH in the indicated UL subframe, so for example 4 in the PCell's subframe #3 means a PUCCH in subframe #3 will carry the ACK/NACK for the PDSCH that was located 4 subframes prior to that subframe #3.

FIG. 1 illustrates the particular case in which the UL subframes in the SCell form a subset of the UL subframes in the PCell. Specifically, from FIG. 1 it can be seen that:
The DL association set for PCell UL subframe #2 is {n-6, n-7}
The DL association set for SCell UL subframe #2 is {n-4, n-6, n-7, n-8}
The overlapped part of the two association sets is {n-6, n-7}

In this case, the PDSCH HARQ-ACK timing on the SCell shall follow its own TDD configuration (configuration #2 in the FIG. 1 example), because following the PCell HARQ timing will result in inefficient use of DL subframes of the SCell. Thus in addition to assuming that cross carrier scheduling is configured, the examples below further assume that the PDSCH HARQ-ACK timing on the SCell shall follow its own TDD configuration.

This does not resolve the resource allocations for HARQ-ACK feedback. One particular problem with resource allocation in this case is that in conventional LTE® the PUCCH resource is implicitly linked to the PDCCH CCE as noted in the background section above, if cross-carrier scheduling from the PCell is configured. But the example of FIG. 1 reveals that at least subframe n-4 and n-8 on the SCell cannot always use implicit resources, since they are not part of the DL associate set of the PCell. For example, if
in PCell DL subframe n-6 a PDCCH with starting CCE index #x is used as the DL grant; and
in SCell DL subframe n-4 a PDCCH with starting CCE index #x is used as DL grant;
   then the two implicit resources would collide with each other.

One possible solution to the resource allocation for the FIG. 1 example might be:
if UE has PDSCH corresponding to subframe n-7 and n-6 on the PCell, the UE will have two implicit format 1b resources {Rpcell1, Rpcell2} linked to the PDCCH CCE;
if the UE has PDSCH corresponding to subframe n-7 and n-6 on the SCell, the UE will have two implicit format 1b resources {Rscell1, Rscell2} linked to the PDCCH CCE.
   Based on these four resources, channel selection can be done, and so the potential resource collisions with subframe n-8 and n-4 do not matter.

But if the UE misses the cross-carrier-grant corresponding to the SCell PDSCH in subframe n-7 and n-6 there might be an issue because an implicit resource is not always available. One possible resolution is to always use an explicit resource if cross-carrier scheduling is used, such as by means of an ACK resource indicator (ARI). In that case all the transmit power control (TPC) bits in the PDCCH corresponding to the SCell PDSCH will be used as ARI and always indicate an explicit resource. Rel-10 of LTE® in general uses an implicit PUCCH resource allocation with cross carrier scheduling but explicit PUCCH resource allocation without cross carrier scheduling (see 3GPP TS 36.213 v10.4.0, Physical layer procedure; sections 10.1.2.2.1 and 10.1.3.2.1).

But to always use explicit resources indicated by ARI is inefficient, since the implicit resources Rscell1 and Rscell2 as described above would be wasted in any case. In practice there is a non-negligible probability of such resource wasting, and part of the motivation of component carrier-specific TDD UL/DL configurations full duplex mode is to make use of the DL resources from the SCell. But it does not appear possible to adjust the resource allocation (that is, switching between implicit resources and explicit resources) based on which PDCCHs are received by the UE, because in practice there is the possibility that the UE never receives a PDCCH addressed to it. Such a missing PDCCH is in fact a specific error that the development of LTE-A® deals with elsewhere, which the UE signals in its HARQ signaling as a discontinuous transmission (DTX). The examples below show how these teachings provide improved resource allocation to avoid the resource wasting noted above, but with only limited extra cost.

From the above analysis the inventors have concluded that for the cross carrier scheduling case an implicit resource allocation cannot always work, and also that the volume of wasted resources is too great if explicit resource allocation is employed. Neither solution is seen to be sufficiently effective.

Embodiments of these teachings, which are set forth with more particularity in the examples below, enable the UE to switch between using implicit or using explicit resources. Note this switching does not imply that there is also some new way of implicitly or explicitly assigning the PUCCH resources to a UE, but rather that the UE knows from the switching signaling or mechanism whether it should use implicit resource mapping (e.g., via the CCE of the PDCCH) to find the PDSCH for a given PUCCH or should use an explicitly signaled PDSCH to associate with a given PUCCH according to the signaling or the mechanism detailed in the below examples.

For added clarity these terms are particularly defined for the examples in an LTE® system. An implicit PUCCH resource allocation means the PUCCH resource is linked to the CCE index of the DL grant (the PDCCH) which allocated the PDSCH that is being ACK'd/NACK'd in that PUCCH resource. In LTE® Rel-8 implicit PUCCH resource allocation for HARQ-ACK feedback is always used, while in LTE® Rel-10 implicit resource allocation is always used whenever the SCell is cross-scheduled from the PCell (and explicit resource allocation is used whenever cross carrier scheduling is not configured for the SCell). An explicit resource allocation means the PUCCH resource is explicitly indicated by higher layer or physical layer signaling, which is different from implicit resource allocation.

The following assumptions are made for these examples below, which is specific for deployment in the current LTE® system but which are not limiting to the broader teachings herein. First, the PDSCH HARQ-ACK timing on the SCell follows the configuration that is indicated in the SCell's system information block 1 (SIB1) which is broadcast to the UEs. Second, the PUCCH format 1b with channel selection is configured. Third, the PCell and one SCell are configured for a UE, and the SCell is cross-carrier scheduled by the PCell. And finally, for the second embodiment the TPC bits in the PDCCH corresponding to the PDSCH on the SCell are reused as ART bits.

To describe more generally, let us term the downlink subframes associated with a given uplink subframe for a particular DL/UL configuration as a DL configuration set. For HARQ timing following the PCell TDD configuration let S1 represent the downlink association set of UL subframe #n, and for HARQ timing following the SCell TDD configuration let S2 represent the downlink association set of UL subframe #n. Either of S1 or S2 may have one or more than one DL subframe members as in the FIG. 1 example. The examples below apply (at least) for the case in which the association set for a UL subframe #n in the PCell only partially overlaps with the association set for a UL subframe #n in the SCell; that is, when S1 partially but not fully overlaps with S2.

For at least this partial overlap case there are two examples below which detail two different embodiments of these teachings. The first embodiment introduces higher layer configuration on whether implicit resources are always used, or explicit resource are always used. The second embodiment redefines some DCI fields to indicate whether implicit or explicit resources shall be used. As will be seen for this second embodiment, the carrier indication field (CIF) bits and/or the ARI bits in the DCI are redefined but in other implementations the redefinition may be of other PDCCH bits, and in other radio access technologies the redefined bits may be known by a different name.

For the first embodiment, higher layer configuration, there are two options. The UE is configured via higher layer: a) to always use implicit PUCCH resources for HARQ-ACK for the SCell PDSCH, or b) to always use explicit PUCCH resources for HARQ-ACK for the SCell PDSCH.

The design choice that the higher layer configuration indicates to always use implicit PUCCH resources for HARQ-ACK for the SCell PDSCH [option a) above] can avoid resource wasting if the eNB decides that the DL traffic for the UE is high. This is because when the UE has a large volume of DL traffic there is no clear benefit from only scheduling DL subframe the non-overlapping subframes n-4 and n-8 but not the overlapping subframes n-6 and n-7 in a radio frame (referring to the specific S1 and S2 sets in FIG. 1). Wasting radio resources is also avoided where the eNB decides that even if only 2 out of the 4 subframes in the DL association set for a given SCell UL subframe needs to be scheduled, the scheduling loss from restricting to subframe n-6 and n-7 is acceptable (also referring to the specific S1 and S2 sets in FIG. 1). In both these scenarios the UE can assume implicit resources are always available, otherwise the UE will consider the PDCCH missing (the UE determines that there was PDCCH addressed to it which it did not receive or did not decode properly) and would report a discontinuous transmission (DTX) corresponding to the SCell PDSCH. In other scenarios where the UE does not have a large volume of DL traffic and/or the eNB decides the above scheduling restrictions are too wasteful of radio resources, to avoid the resource collision issue the eNB can configure a UE to use the other option above, namely that the eNB and UE will always use explicit PUCCH resources for HARQ-ACK for the SCell PDSCH.

The second embodiment involves redefining some DCI fields to indicate whether implicit or explicit resources shall be used for HARQ-ACK for the SCell PDSCH. There are at least two different ways to implement this redefining of bits.

In a first implementation of this second embodiment, a spare (currently unused) state of the CIF bits is used by the eNB to indicate whether the UE shall use explicit resources. The CIF in a given DCI format is used to indicate which SCell the DL grant shall apply to if cross carrier scheduling is configured. In the current version of LTE® there are three bits in the CIF, which means that so long as the SCell number configured with the cross carrier scheduling is less than 8 there should be a spare state of those three bits in the CIF. As an example of this first implementation, if the CIF state=000 indicates a DCI for a PCell PDSCH, and the CIF state=001 indicates a DCI for the SCell PDSCH, then the CIF state=111 redefined by these teachings to indicate that the UE shall use explicit PUCCH resources and the UE will understand anything other than CIF state=111 to mean that it shall use implicit PUCCH resources.

In a second implementation of this second embodiment, a state of the ARI bits is redefined to indicate whether the UE shall use explicit resources. In the current version of LTE® Rel-10, the ART field in a given DCI is 2 bits in length and ARI states 01, 11, and 10 are used to indicate particular ACK (PUCCH) resources. This leaves ARI state=00 unused, and so in this example that is the state which is redefined by these teachings. If the eNB decides that the UE will not have any implicit PUCCH resources corresponding to the SCell PDSCH, then the eNB can use the three ART states other than 00 to indicate the explicit resource to a UE. In this second implementation ART state=00 is redefined to mean that the UE shall use implicit PUCCH resources, while all other ARI states mean that UE shall use explicit PUCCH resources. These example ARI states are specific for current unused CIF/ARI states, other states may be used for the above indications in other deployments of these teachings. More generally, there is a predetermined CIF or ARI state that the UE and the eNB understand as indicating to use implicit PUCCH resources, and other CIF or ARI states are predetermined to indicate the use of explicit PUCCH resources.

Now are presented a few examples for the second embodiment in which the CIF state=111 is redefined to indicate to the UE that it shall use explicit PUCCH resources for the HARQ-ACK of the SCell PDSCH. Assume that the SCell index corresponds to CIF state=101, though as noted above the UE is able to decide that the DL grant (PDCCH) is for the SCell anytime the CIF field is present in the DCI. Assume also as noted above that CIF state=111 is redefined to indicate that a UE is to use implicit PUCCH resources. In these examples the UE needs four PUCCH resources in total to use PUCCH format 1b with channel selection. Using the example of UL subframe n=2 as shown in FIG. 1, the DL association set S1 for the PCell is {n-6, n-7} and the DL association set S2 for the SCell is {n-4, n-6, n-7, n-8}, so the overlapped PUCCH resources for PDSCH channel selection are all of S1 and the non-overlapped PUCCH resources for PDSCH channel selection are {n-4, n-8}.

As a first example, assume the eNB sends four PDCCH which schedules subframes n-6 and n-7 on the PCell and which also cross-scheduled subframes n-6 and n-7 on the SCell. The eNB will see that there is no potential for PUCCH conflict if the PUCCHs are implicitly defined by the lowest CCE of the PDCCH that schedules the PDSCHs which are to be ACK'd by the UE in those two SCell PUCCHs, so the eNB will choose that for this PDCCH the two PUCCH resources for channel selection in the SCell will be implicitly allocated. The eNB will then set the CIF state in the PDCCH to 111 to indicate to the UE that the two PUCCH resources that ACK the SCell are to be those two PUCCH resources which are implicitly allocated by their linkage to subframe n-6 and n-7.

As a second example, assume the eNB sends six PDCCH which again schedules subframes n-6 and n-7 on the PCell and but this time it also cross-scheduled subframes n-6, n-7, n-4 and n-8 on the SCell. The eNB will see that there is no potential for PUCCH conflict if the PUCCHs are implicitly defined by the lowest CCE of the PDCCH that schedules the PDSCHs on the SCell. As noted above, there is no potential for conflict anyway for the n-4 and n-8 subframes, and for this example assume the eNB is able to use different CCEs to schedule the n-6 and n-7 PDSCHs in the PCell and the SCell so there is no conflict there either. The eNB will choose that for this PDCCH the four PUCCH resources for channel selection in the SCell will be implicitly allocated. The eNB will then set the CIF state in the PDCCH to 111 to indicate to the UE that the four PUCCH resources that ACK the SCell are to be those which are implicitly allocated by their linkage to subframe n-6 and n-7, n-4 and n-8. Now if the UE detects CIF state=111 but does not detect (or cannot properly decode) the PDCCH allocations corresponding to the PDSCHs in SCell subframe n-6 and n-7, the UE will know that it has missed those allocations and signal DTX in place of its ACK in the implicitly allocated PUCCH resources.

As a third example, assume the eNB sends four PDCCH which schedules subframes n-6 and n-7 on the PCell and which also cross-scheduled subframes n-4 and n-8 on the SCell. There are then four PUCCH resources for channel selection. In this case assume the eNB sees that due to its scheduling constraints of high traffic load it is not able to use different CCEs to start the PDCCHs. Seeing a potential for PUCCH conflict if the PUCCHs are implicitly defined, the eNB chooses that for this PDCCH the two PUCCH resources for channel selection in the SCell will be explicitly allocated. The eNB will then set the CIF state in the PDCCH to something other than 111 to indicate to the UE that the two PUCCH resources that ACK the SCell are to be explicitly signaled. Since in this case the CIF was used to inform the UE of the switch to explicit PUCCH resources, the eNB uses the ARI field to tell the UE exactly which PUCCH resources it should use to ACK the PDSCHs which are on the SCell at subframes n-4 and n-8.

In all of the above examples, the PUCCH resources for the PDSCHs on the PCell follow a default rule, such as is the current practice in LTE® Rel-10 that whenever cross carrier scheduling is used the PUCCH resources for the PDSCHs on the PCell will be implicitly allocated. In other deployments there may be a different default rule for the PCell allocations, but the salient point is that the eNB has the option to switch on the SCell how the PUCCHs are allocated whereas on the PCell it does not.

The above teachings are also extended as shown below to the case in which multiple transmission time intervals (TTIs) are used. As an example assume multiple TTIs schedule the SCell DL subframe #3 in FIG. 1, and that cross scheduling is configured for the SCell. Multiple TTI scheduling in this example means that SCell subframe #3 is scheduled for example by a grant from the eNB that the UE received in PCell DL subframe #1, due to the fact that the TDD UL/DL configuration for the PCell renders subframe #3 in the PCell as a UL subframe which of course cannot be used to transmit a DL grant. A similar case can be seen at FIG. 1 when SCell DL subframe #8 is scheduled by a grant received in PCell DL subframe #6.

In this case, there is still the issue that the DL association set for the SCell of UL subframe #2 is {n-4, n-6, n-7, n-8} but it is {n-6, n-7} for PCell UL subframe #2. At least the PDSCH in SCell subframe n-8 cannot make use of implicit resources because it has a different HARQ timing as compared with the PCell. For SCell subframe n-4, there are a few possible cases with multiple TTI scheduling, explored below in detail.

For the case in which PDSCHs in SCell subframe n-4 and n-6 are granted by a single PDCCH transmitted in PCell DL subframe n-6, then:
PUCCH resources corresponding to PDSCH in SCell subframe n-4 can be some implicit resource linked to the PDCCH CCE index (e.g., linked to n_cce+1), or
PUCCH resources corresponding to PDSCH in SCell subframe n-4 can be explicit resource.

When PDSCHs in SCell subframe n-4 and n-6 are granted by separate PDCCHs transmitted in PCell DL subframe n-6, then:
PUCCH resources corresponding to PDSCH in SCell subframe n-4 can be some implicit resource linked to the PDCCH CCE index (e.g., linked to n_cce)

To summarize, at least for PDSCH in SCell subframe n-8 or for a PDSCH in SCell subframe n-4, for the case in which implicit resources are not available for SCell PDSCHs, then the PUCCH resources can be explicitly allocated. In all other cases they may be implicitly allocated.

Certain of the above embodiments provide the technical effect of improving resource efficiency by avoiding having to always use explicitly allocated PUCCH resources. Another technical effect is that these solutions limit the added complexity; with the first embodiment the extra signaling overhead is in a higher layer and is very small whereas with the second embodiment the DCI size is unchanged and the extra UE complexity is limited. Additionally, at least the second embodiment is able to deal with the error case from a missing PDCCH in that the UE still knows the PUCCH in which to send its DTX to indicate to the eNB that the UE missed it. With reference to DCI formats in LTE®, these teachings can be readily employed when format 3 is not supported by a UE or network, and can additionally support switching between format 3 and format 1b by defining explicit PUCCH format 3 resources instead of format 1b.

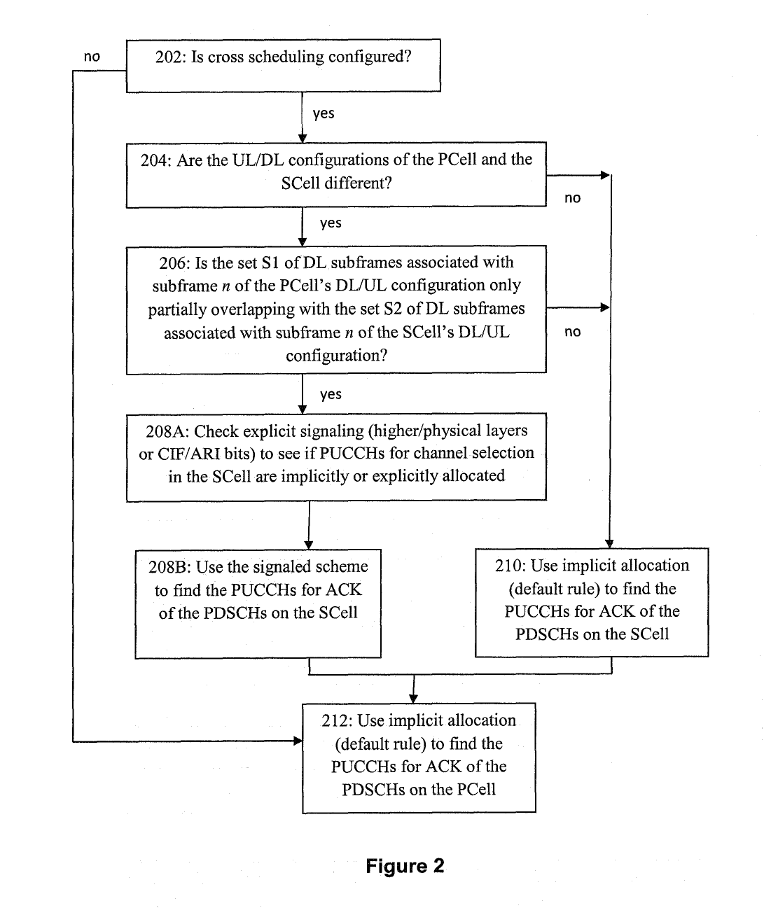

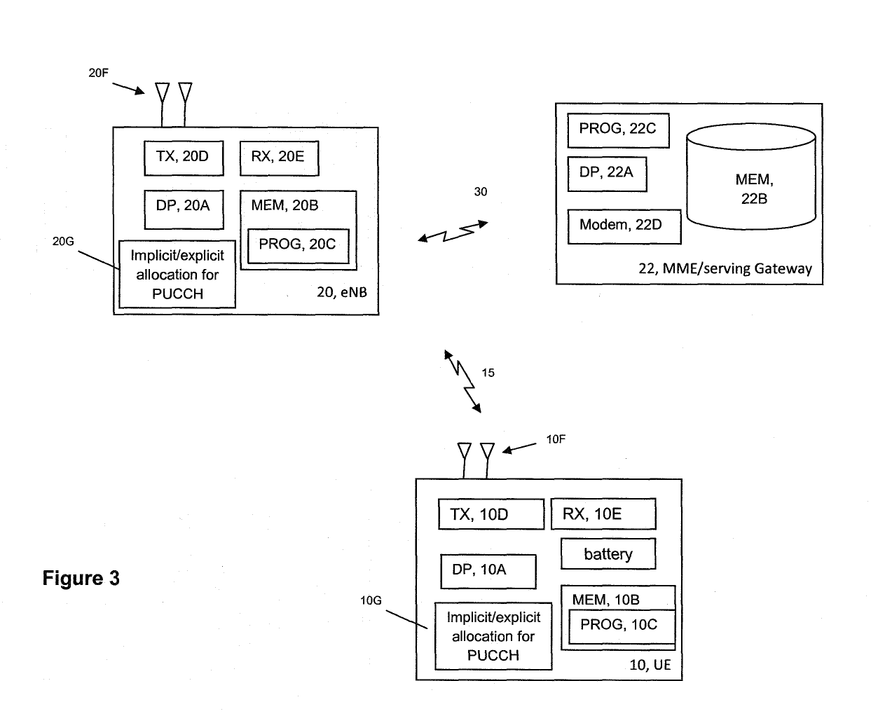

FIG. 2 is a logic flow diagram which summarizes some example embodiments of the invention. FIG. 2 summarizes in a generic manner some of the above teachings so they reflect actions/decisions by the eNB which selects and signals whether the PUCCH resource allocation is to be implicit or explicit so it knows where to look for the UE's ACK (or DTX), and also actions/decisions by the UE which reads that received signaling to select whether the PUCCH resource allocation is implicit or explicit so it knows what PUCCH resources in which to send its ACK (or DTX). An apparatus implementing the actions/decisions shown at FIG. 2 may be the entire eNB 20 or other access node shown at FIG. 3, or the entire UE 10 also shown at FIG. 3, or may be one or more components of either of them such as a modem, chipset, or the like. FIG. 2 may be considered to illustrate the operation of a method for operating a device, and a result of execution of a computer program tangibly stored in a computer readable memory, and a specific manner in which components of an electronic device are configured to cause that electronic device/system to operate.

The blocks of FIG. 2 and the functions they represent are non-limiting examples, and may be practiced in various components such as integrated circuit chips and modules. Exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Such circuit/circuitry embodiments include any of the following: (a) hardware-only circuit implementations (such as implementations in only analog and/or digital circuitry) and (b) combinations of circuits and software (and/or firmware), such as: (i) a combination of processor(s) or (ii) portions of processor(s)/software (including digital signal processor(s)), software, and memory(ies) that work together to cause an apparatus, such as a network access node/AP, to perform the various functions summarized at FIG. 5) and (c) circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” also covers, for example, a baseband integrated circuit or applications processor integrated circuit for a mobile phone or terminal/user equipment or a similar mobile data sink device.

Specifically, when there is a PDCCH for the eNB device to send, or a PDCCH that the UE device receives, at block 202 of FIG. 2 the device first checks at block 202 whether cross carrier scheduling is configured. If yes then the flow proceeds to block 204 where the device checks whether the UL/DL configurations of the PCell and of the SCell are different. If yes then the device checks at block 206 whether the first set (S1) of DL subframes associated with a given subframe n of the PCell's UL/DL configuration only partially overlaps the second set (S2) of DL subframes associated with that same subframe n of the SCell's UL/DL configuration.

If again yes then the flow proceeds to block 208A where explicit signaling, sent by the eNB and received by the UE, indicates whether the PUCCHs for channel selection in the SCell are to be implicitly or explicitly allocated. In the above examples the signaling indicated one of these and the lack of analogous signaling indicated the other by default, but in other embodiments there may be one bit value that indicates implicit PUCCH allocation and a different bit value that means explicit PUCCH allocation. In any case even the explicit signaling of one of those two choices as in the above examples is an indication whether explicit or implicit allocation is in force for this PDCCH. After making the selection according to the block 208A signaling then at block 208B the device uses the selected allocation type (implicit or explicit) that was indicated by the signaling to find which PUCCH resources in subframe n of the PCell are to be used for the HARQ feedback for the PDSCH that was scheduled on the SCell (see 3GPP TS 36.213 v10.5.0 at section 10.1 for the proposition that all PUCCHs are to be transmitted in the PCell).

If block 202 is negative, there is no cross scheduling on the SCell and the process of FIG. 2 proceeds directly to block 212 where the PUCCHs for the HARQ feedback of the PDSCHs on the PCell are implicitly allocated; there are no PDSCHs on the SCell for which to provide feedback. If any of the checks at blocks 204 or 206 are negative, then there is/are PDSCHs on the SCell that are cross scheduled, and the PUCCHs for the HARQ feedback of those PDSCHs on the SCell are implicitly allocated. This may be considered in general as a default rule, which in the above examples is according to conventional LTE® rules. In another embodiment the default rule concerning the PUCCHs that give feedback for the SCell PDSCHs may be explicitly allocated, but in the above examples this was not an efficient use of the control radio resources.

Whether the PUCCHs for the HARQ feedback for the PDSCHs on the SCell were found from block 208B or from 210, the PUCCH resources for the HARQ feedback for the PDSCHs on the PCell are always implicitly allocated according to the above examples as shown at block 212. This default rule concerning the PUCCHs that give feedback for the PCell PDSCHs can also be explicitly allocated in other embodiments.

The process of FIG. 2 may be stated more generally as, for a DL resource grant on a first component carrier CC having a first DL to UL subframe configuration that cross schedules (block 202 of FIG. 2) to a second CC having a different second DL to UL subframe configuration (block 204), determine whether a first set S1 of DL subframes associated with a subframe n (some particular subframe) of the first DL to UL subframe configuration only partially overlaps with a second set S2 of DL subframes associated with the subframe n (the same particular subframe) of the second DL to UL subframe configuration (block 206). If the determination is that S1 only partially overlaps S2, then utilize explicit signaling to select whether UL radio resources in subframe n for channel selection are implicitly or explicitly allocated (enter block 208A). Else if the determination is that S1 does not only partially overlap S1, utilize a default rule for allocating the UL radio resources in subframe n for channel selection (enter block 210). Specific for LTE®, the DL resource is a PDCCH; the first CC is a PCell; the second CC is a SCell; the explicit signaling comprises either: physical or higher layer signaling which configures a user equipment for the selected implicit or explicit allocations (first embodiment above); or one state of a carrier indication field CIF in the PDCCH (second embodiment above); the UL radio resources in subframe n are PUCCHs in subframe n of the PCell; the channel selection is for a PDSCH; and the default understanding is to utilize implicitly allocated PUCCHs.

Reference is now made to FIG. 3 for illustrating a simplified block diagram of various electronic devices and apparatus that are suitable for use in practicing some example embodiments of this invention. In FIG. 3 there is a wireless communications network that includes a controller of radio access nodes such as mobility management entity MME 22 (which may also serve the function of a serving gateway) and an access node such as an eNB 20. The eNB 20 bi-directionally communicates over a wireless link 15 with multiple UEs which are illustrated by example as the single UE 10. Preferably the eNB 20 also provides connectivity, via data and control link 30 and the MME 22, with further networks such as a publicly switched telephone network, other cellular networks, and/or the Internet.

The UE 10 includes processing means such as at least one data processor (DP) 10A, storing means such as at least one computer-readable memory (MEM) 10B storing at least one computer program (PROG) 10C, communicating means such as a transmitter TX 10D and a receiver RX 10E for bidirectional wireless communications with the network access node/eNB 20 via one or more antennas 10F. The UE 10 may also have software at 10G for discovering whether certain circumstances are present for there to be an option whether a certain type of resource allocation is explicit or implicit and for making the proper selection from received signaling, as is detailed more particularly in the above examples.

The eNB 20 also includes processing means such as at least one data processor (DP) 20A, storing means such as at least one computer-readable memory (MEM) 20B storing at least one computer program (PROG) 20C, and communicating means such as a transmitter TX 20D and a receiver RX 20E for bidirectional wireless communications with the UE 10 via one or more antennas 20F. The eNB 20 may also have software at 20G for choosing under certain circumstances whether to use explicit or implicit resource allocation for the PUCCHs as is detailed more particularly in the above examples, and such software is also for signaling that allocation to the UE when those circumstances are present.

For completeness there is also shown the MME 22 which has its own processing means such as at least one data processor (DP), storing means such as at least one computer-readable memory (MEM) 22B storing at least one computer program (PROG) 22C, and communicating means such as a modem 22D for bidirectional communications with the eNB 20 via the data/control path 30.

While not particularly illustrated for the UE 10 or for the eNB 20, those devices are also assumed to include as part of their wireless communicating means a modem which may be inbuilt on an RF front end chip within those devices 10, 20 and which also carries the TX 10D/20D and the RX 10E/20E.

At least one of the PROGs 20C/20G in the eNB 20 and/or PROGs 10C/10G in the UE 10 is assumed to include program instructions that, when executed by the associated DP 10A/20A, enable the device to operate in accordance with the exemplary embodiments of this invention as detailed above, particularly with respect to FIG. 2. In this regard the exemplary embodiments of this invention may be implemented at least in part by computer software stored on the MEM 10B/20B which is executable by the DP 10A/20A of the UE 10/eNB 20; or by hardware, or by a combination of tangibly stored software and hardware (and tangibly stored firmware). Electronic devices implementing these aspects of the invention may not be the entire UE 10/eNB 20, but exemplary embodiments may be implemented by one or more components of same such as the above described tangibly stored software, hardware, firmware and DP, modem, system on a chip SOC or an application specific integrated circuit ASIC.

In general, the various embodiments of the UE 10 can include, but are not limited to personal portable digital devices having wireless communication capabilities, including but not limited to user equipments, cellular telephones, navigation devices, laptop/palmtop/tablet computers, digital cameras and Internet appliances, as well as machine-to-machine devices such as those implied by FIG. 1A which operate without direct user action.

Various embodiments of the computer readable MEMs 10B, 20B, 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Depending on the implementation the database system memory 22B may be a disc array. Various embodiments of the DPs 10A, 20A, 22A include but are not limited to general purpose computers, special purpose computers, microprocessors, digital signal processors (DSPs), and multi-core processors.

Some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. A method for selecting uplink radio resources, comprising:
for a downlink resource grant on a first component carrier having a first downlink to uplink subframe configuration that cross schedules to a second component carrier having a different second downlink to uplink subframe configuration, determining whether a first set of downlink subframes associated with a particular subframe of the first downlink to uplink subframe configuration only partially overlaps with a second set of downlink subframes associated with the particular subframe of the second downlink to uplink subframe configuration; and
if the determination is that the first set only partially overlaps the second set, then utilizing explicit signaling to select whether uplink radio resources in subframe n for channel selection are implicitly or explicitly allocated;
else if the determination is that the first set does not only partially overlap the second set, utilizing a default rule for allocating the uplink radio resources in subframe n for channel selection.

2. The method according to claim 1, in which:
the downlink resource grant is a physical downlink control channel (PDCCH);
the first component carrier is a primary cell (PCell);
the second component carrier is a secondary cell (SCell);
the explicit signaling comprises either: higher layer signaling which configures a user equipment for the selected implicit or explicit allocations; or one state of a carrier indication field (CIF) or acknowledgment resource indicator in the PDCCH;
the uplink radio resources in particular subframe are physical uplink control channels (PUCCHs) in the particular subframe of the PCell;
the channel selection is for a physical downlink shared channel (PDSCH); and
the default understanding is to utilize implicitly allocated PUCCHs.

3. The method according to claim 1, in which the explicit signaling comprises a predetermined carrier indication field (CIF) state which indicates the uplink radio resources in the particular subframe for channel selection are implicitly allocated.

4. The method according to claim 1, in which the explicit signaling comprises any of a plurality of carrier indication field (CIF) states, each of which indicates the uplink radio resources in the particular subframe for channel selection are explicitly allocated by an acknowledgment resource indicator.

5. The method according to claim 1, in which the method is executed by a user equipment which receives the explicit signaling.

6. The method according to claim 1, in which the method is executed by a network access node which sends the explicit signaling.

7. An apparatus for selecting uplink radio resources, comprising:
a processing system comprising at least one memory including computer program code and at least one processor;
in which the processing system is configured to cause the apparatus to perform:
for a downlink resource grant on a first component carrier having a first downlink to uplink subframe configuration that cross schedules to a second component carrier having a different second downlink to uplink subframe configuration, determining whether a first set of downlink subframes associated with a particular subframe of the first downlink to uplink subframe configuration only partially overlaps with a second set of downlink subframes associated with the particular subframe of the second downlink to uplink subframe configuration; and
if the determination is that the first set only partially overlaps the second set, then utilizing explicit signaling to select whether uplink radio resources in the particular subframe for channel selection are implicitly or explicitly allocated;
else if the determination is that the first set does not only partially overlap the second set, utilizing a default rule for allocating the uplink radio resources in the particular subframe for channel selection.

8. The apparatus according to claim 7, in which:
the downlink resource grant is a physical downlink control channel (PDCCH);
the first component carrier is a primary cell (PCell);
the second component carrier is a secondary cell (SCell);
the explicit signaling comprises either: higher layer signaling which configures a user equipment for the selected implicit or explicit allocations; or one state of a carrier indication field (CIF) or acknowledgment resource indicator in the PDCCH;
the uplink radio resources in the particular subframe are physical uplink control channels (PUCCHs) in the particular subframe of the PCell;
the channel selection is for a physical downlink shared channel (PDSCH); and
the default understanding is to utilize implicitly allocated PUCCHs.

9. The apparatus according to claim 7, in which the explicit signaling comprises a predetermined carrier indication field (CIF) state which indicates the uplink radio resources in the particular subframe for channel selection are implicitly allocated.

10. The apparatus according to claim 7, in which the explicit signaling comprises any of a plurality of carrier indication field (CIF) states, each of which indicates the uplink radio resources in the particular subframe for channel selection are explicitly allocated by an acknowledgment resource indicator.

11. The apparatus according to claim 7, in which the apparatus comprises a user equipment which receives the explicit signaling.

12. The apparatus according to claim 7, in which the apparatus comprises a network access node which sends the explicit signaling.

13. A computer readable memory storing a set of instructions, which when executed on a radio communications device, causes the radio communications device to perform the steps of:
for a downlink resource grant on a first component carrier having a first downlink to uplink subframe configuration that cross schedules to a second component carrier having a different second downlink to uplink subframe configuration, determining whether a first set of downlink subframes associated with a particular subframe of the first downlink to uplink subframe configuration only partially overlaps with a second set of downlink subframes associated with the particular subframe of the second downlink to uplink subframe configuration; and
if the determination is that the first set only partially overlaps the second set, then utilizing explicit signaling to select whether uplink radio resources in the particular subframe for channel selection are implicitly or explicitly allocated;
else if the determination is that the first set does not only partially overlap the second set, utilizing a default rule for allocating the uplink radio resources in the particular subframe for channel selection.

14. The computer readable memory according to claim 13, in which:
the downlink resource grant is a physical downlink control channel (PDCCH);
the first component carrier is a primary cell (PCell);
the second component carrier is a secondary cell (SCell);
the explicit signaling comprises either: higher layer signaling which configures a user equipment for the selected implicit or explicit allocations; or one state of a carrier indication field CIF or acknowledgment resource indicator in the PDCCH;
the uplink radio resources in the particular subframe are physical uplink control channels (PUCCHs) in subframe n of the PCell;
the channel selection is for a physical downlink shared channel (PDSCH); and
the default understanding is to utilize implicitly allocated PUCCHs.

15. The computer readable memory according to claim 13, in which the explicit signaling comprises a predetermined carrier indication field (CIF) state which indicates the uplink radio resources in the particular subframe for channel selection are implicitly allocated.

16. The computer readable memory according to claim 13, in which the explicit signaling comprises any of a plurality of carrier indication field (CIF) states, each of which indicates the uplink radio resources in the particular subframe for channel selection are explicitly allocated by an acknowledgment resource indicator.

17. The computer readable memory according to claim 13, in which the radio communications device comprises a user equipment which receives the explicit signaling.

18. The computer readable memory according to claim 13, in which the radio communications device comprises a network access node which sends the explicit signaling.

19-20. (canceled)

21. The apparatus according to claim 11, wherein the user equipment receives the explicitly signaling from an eNodeB operating in a LTE radio network.

22. The apparatus according to claim 12, wherein the network access node in an eNodeB in a LTE radio network.
